(19) United States
(12) Patent Application Publication
(10) Pub. No.: US 2025/0286600 A1
(43) Pub. Date: Sep. 11, 2025

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Shukun Wang, Dongguan (CN); Wenhong Chen, Dongguan (CN); Cong Shi, Dongguan (CN)

(73) Assignee: GUANGDONG OPPO MOBILE TELECOMMUNICATIONS CORP., LTD., Dongguan (CN)

(21) Appl. No.: 19/216,547

(22) Filed: May 22, 2025

Related U.S. Application Data
(63) Continuation of application No. PCT/CN2022/134657, filed on Nov. 28, 2022.

(51) Int. Cl. H04B 7/06; H04B 17/318; H04W 74/0833

(52) U.S. Cl. CPC H04B 7/0695; H04B 17/328; H04W 74/0833

(57) ABSTRACT

A wireless communication method, a terminal device, and a network device are provided. In the method, a terminal device initially accesses a first cell, wherein the first cell is covered by a plurality of beam layers, and different beam layers in the plurality of beam layers correspond to different coverage ranges in the first cell.

### CROSS-REFERENCE TO RELATED APPLICATION

This application is a continuation of International Patent Application No. PCT/CN2022/134657 filed on Nov. 28, 2022, disclosure of which is hereby incorporated by reference in its entirety.

### TECHNICAL FIELD

Embodiments of the disclosure relate to the technical field of mobile communication, and in particular to a wireless communication method, a terminal device, and a network device.

### BACKGROUND

A beam-based cell may effectively meet coverage requirements. At present, a beam distribution in the cell has limitations, which may result in terminal devices located in different areas of the cell being within a coverage area of a same beam. For example, terminal devices located at the center of the cell and those at the edge of the cell may be within the coverage area of the same beam. However, the coverage strength for terminal devices in different areas varies, with terminal devices closer to the center of the cell generally receiving stronger coverage and those farther from the center of the cell receiving weaker coverage. A network side generally identifies a location of a terminal device based on a beam used by the terminal device, which results in the network side being unable to more accurately identify the area where the terminal device is located.

### SUMMARY

Embodiments of the disclosure provide a wireless communication method, a terminal device, and a network device.

A wireless communication method according to an embodiment of the disclosure includes the following operation. A terminal device performs initial access to a first cell, herein the first cell is covered by multiple beam layers, and different beam layers of the multiple beam layers correspond to different coverage areas within the first cell.

A terminal device according to an embodiment of the disclosure includes a processor and a memory, wherein the memory is configured to store a computer program, and the processor is configured to call and run the computer program stored in the memory to cause the terminal device to perform an operation of: performing initial access to a first cell, wherein the first cell is covered by a plurality of beam layers, and different beam layers of the plurality of beam layers correspond to different coverage areas within the first cell.

A network device according to an embodiment of the disclosure includes a processor and a memory, wherein the memory is configured to store a computer program, and the processor is configured to call and run the computer program stored in the memory to cause the network device to perform an operation of: performing beam scanning to achieve coverage of a first cell through a plurality of beam layers, wherein different beam layers of the plurality of beam layers correspond to different coverage areas within the first cell.

### BRIEF DESCRIPTION OF THE DRAWINGS

The drawings described herein are intended to provide further understanding of the disclosure and constitute a part of the disclosure. The illustrative embodiments of the disclosure and their descriptions are intended to explain the disclosure and do not constitute undue limitations on the disclosure. In the drawings:

FIG. 1 is a schematic diagram of an application scenario of an embodiment of the disclosure;

FIG. 2-1 is a schematic diagram of an omnidirectional antenna-based cell;

FIG. 2-2 is a schematic diagram of a beam-based cell;

FIG. 3 is a schematic diagram of a multiple beam layers-based cell according to an embodiment of the disclosure;

FIG. 4 is a schematic flowchart of a wireless communication method according to an embodiment of the disclosure;

FIG. 5-1 is a first schematic diagram of coverage areas of beam layers according to an embodiment of the disclosure;

FIG. 5-2 is a second schematic diagram of coverage areas of beam layers according to an embodiment of the disclosure;

FIG. 5-3 is a third schematic diagram of coverage areas of beam layers according to an embodiment of the disclosure;

FIG. 6 is a first schematic diagram of a structure of a wireless communication apparatus according to an embodiment of the disclosure;

FIG. 7 is a second schematic diagram of a structure of a wireless communication apparatus according to an embodiment of the disclosure;

FIG. 8 is a schematic structural diagram of a communication device according to an embodiment of the disclosure;

FIG. 9 is a schematic structural diagram of a chip according to an embodiment of the disclosure; and

FIG. 10 is a schematic block diagram of a communication system according to an embodiment of the disclosure.

### DETAILED DESCRIPTION

The technical solutions in the embodiments of the disclosure are described in the following with reference to the drawings in the embodiments of the disclosure. It is obvious that the described embodiments are some rather than all of the embodiments of the disclosure. All other embodiments obtained by a person of ordinary skill in the art based on the embodiments of the disclosure without creative efforts shall fall within the protection scope of the disclosure.

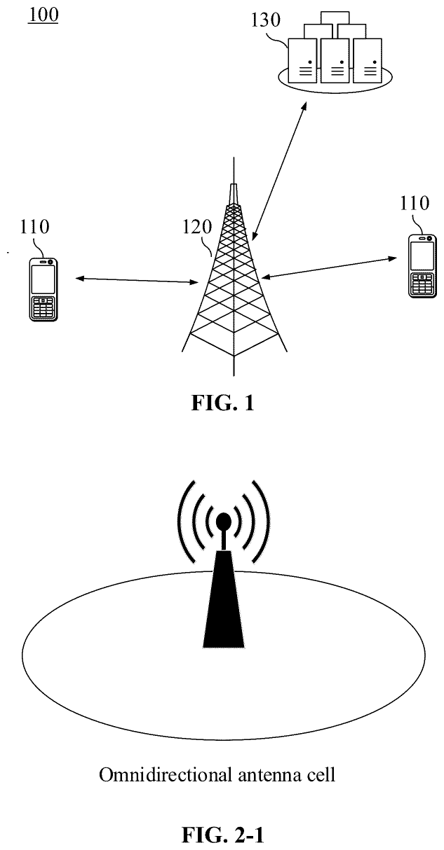

FIG. 1 is a schematic diagram of an application scenario of an embodiment of the disclosure.

As shown in FIG. 1, a communication system 100 may include terminal devices 110 and a network device 120. The network device 120 may communicate with the terminal devices 110 over an air interface. Multi-service transmission is supported between the terminal devices 110 and the network device 120.

It should be understood that the communication system 100 is only used as an example for illustrative purpose in the embodiments of the disclosure, but the embodiments of the disclosure are not limited to this. That is to say, the technical solutions in the embodiments of the disclosure may be applied to various communication systems, such as long term evolution (LTE) systems, LTE time division duplex (TDD), universal mobile telecommunication systems (UMTSs), Internet of things (IoT) systems, narrow band IoT (NB-IoT) systems, enhanced machine-type communication (eMTC) systems, 5G communication systems (also referred to as new radio (NR) communication systems), or future communication systems, etc.

In the communication system 100 shown in FIG. 1, the network device 120 may be an access network device that communicates with the terminal devices 110. The access network device may provide communication coverage for a specific geographic area and may communicate with the terminal devices 110 (e.g., UEs) located within that coverage area.

The network device 120 may be an evolutional node B (eNB or eNodeB) in an LTE system, or a next generation radio access network (NG RAN) device, or a base station (gNB) in an NR system, or a wireless controller in a cloud radio access network (CRAN), or the network device 120 may be a relay station, an access point, a vehicle-mounted device, a wearable device, a hub, a switch, a bridge, a router, or a network device in a future evolutional public land mobile network (PLMN), etc.

The terminal devices 110 may be any terminal device, including but not limited to terminal devices that are connected to the network device 120 or other terminal devices via wired or wireless connections.

For example, each of the terminal devices 110 may refer to an access terminal, a user equipment (UE), a user unit, a user station, a mobile station, a mobile site, a remote station, a remote terminal, a mobile device, a user terminal, a terminal, a wireless communication device, a user agent, or a user apparatus. The access terminal may be a cellular phone, a cordless phone, a session initiation protocol (SIP) phone, an IoT device, a satellite handheld terminal, a wireless local loop (WLL) station, a personal digital assistant (PDA), a handheld device with wireless communication capabilities, a computing device or other processing device connected to a wireless modem, a vehicular device, a wearable device, a terminal device in a 5G network, or a terminal device in future evolution networks.

The terminal devices 110 may be used for device to device (D2D) communication.

The wireless communication system 100 may further include a core network device 130 that communicates with the base station. The core network device 130 may be a 5G Core (5GC) device, such as an access and mobility management function (AMF), an authentication server function (AUSF), a user plane function (UPF), or a session management function (SMF). Optionally, the core network device 130 may also be an evolved packet core (EPC) device in an LTE network, such as a session management function +core packet gateway (SMF+PGW-C) device. It should be understood that SMF+PGW-C may simultaneously perform the functions of both SMF and PGW-C. During network evolution, the aforementioned core network device may also be referred to by other names, or new network entities may be formed by dividing the functions of the core network, and no limits are made thereto in the embodiments of the disclosure.

Various functional units in the communication system 100 may further establish connections and achieve communication through next generation (NG) interfaces.

For example, a terminal device establishes an air interface connection with the access network device through an NR interface for transmitting user plane data and control plane signaling; the terminal device may establish a control plane signaling connection with the AMF through NG interface 1 (referred to as N1); the access network device, such as a next generation wireless access base station (gNB), may establish a user plane data connection with the UPF through NG interface 3 (referred to as N3); the access network device may establish a control plane signaling connection with the AMF through NG interface 2 (referred to as N2); the UPF may establish a control plane signaling connection with the SMF through NG interface 4 (referred to as N4); the UPF may interact user plane data with the data network through NG interface 6 (referred to as N6); the AMF may establish a control plane signaling connection with the SMF through NG interface 11(referred to as N11); and the SMF may establish a control plane signaling connection with the PCF through NG interface 7 (referred to as N7).

FIG. 1 exemplarily illustrates a base station, a core network device, and two terminal devices. Optionally, the wireless communication system 100 may include multiple base station devices and there may be other numbers of terminal devices within a coverage area of each base station. No limits are made thereto in the embodiments of the disclosure.

It should be noted that FIG. 1 is merely an illustrative example of the system applicable to the disclosure. Of course, methods shown in the embodiments of the disclosure may further be applied to other systems. In addition, terms “system” and “network” are often used interchangeably in the disclosure. A term “and/or” in the disclosure is only an association relationship describing associated objects, and indicates that there may be three relationships. For example, A and/or B may indicate three cases: existence of A alone, existence of A and B simultaneously, and existence of B alone. Furthermore, a character “/” in the disclosure generally indicates that preceding and following associated objects are in an “or” relationship. It should also be understood that “indicate” mentioned in the embodiments of the disclosure may be a direct indication or an indirect indication, or may mean that there is an association relationship. For example, A indicates B, which may mean that A indicates B directly (e.g., B may be acquired through A), or may mean that A indicates B indirectly (e.g., A indicates C, and B may be acquired through C), or may mean that there is an association relationship between A and B. It should also be understood that “correspond” mentioned in the embodiments of the disclosure may mean that there is a direct correspondence relationship or an indirect correspondence relationship between two objects, or may mean that there is an association relationship between the two objects, or may mean that there are relationships of indicating and being indicated, configuring and being configured, and the like. It should also be understood that “predefined” or “predefined rules” mentioned in the embodiments of the disclosure may be implemented by pre-storing corresponding codes, tables, or other ways that may be used for indicating related information in devices (e.g., including a terminal device and a network device), and the specific implementation is not limited in the disclosure. For example, predefined may refer to those defined in a protocol. It should also be understood that in the embodiments of the disclosure, the term “protocol” may refer to standard protocols in the field of communications, such as LTE protocols, NR protocols, and related protocols applied in future communication systems, which is not limited in the disclosure.

To facilitate understanding of the technical solutions in the embodiments of the disclosure, the related technologies of the embodiments of the disclosure are described below. The following related technologies, as optional solutions, may be combined arbitrarily with the technical solutions in the embodiments of the disclosure, and all such combinations fall within the scope of protection of the embodiments of the disclosure.

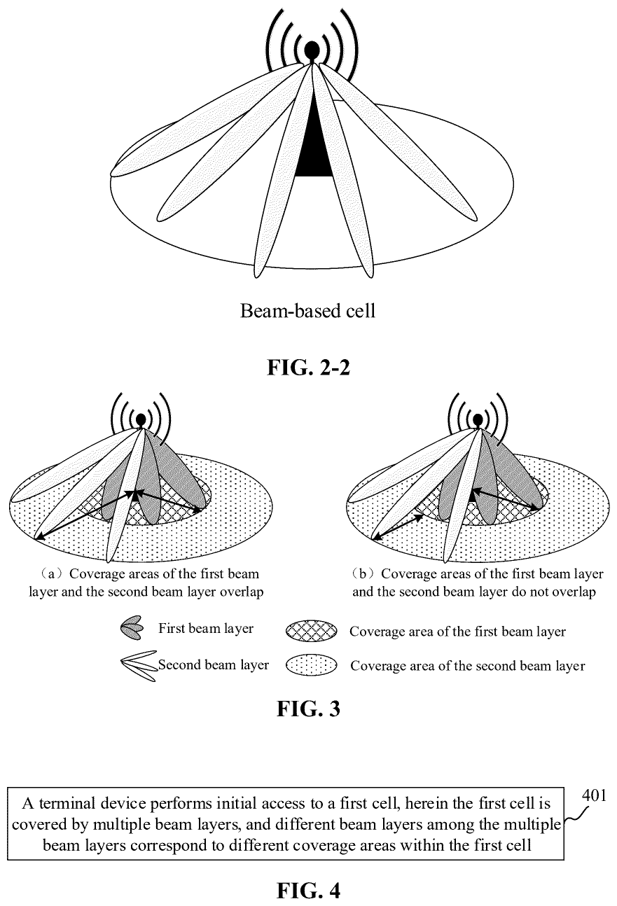

Referring to FIG. 2-1, in 4G LTE, the antenna of the cell is an omnidirectional antenna. Public information (e.g., paging and system broadcasting, etc.) and public signals (e.g., cell reference signals (CRSs)) transmitted by the network side are transmitted as a single instance over the air interface, meaning they occupy a single instance of wireless resources.

Referring to FIG. 2-2, in 5G NR, the antenna of the cell is beam-based. Considering the high band and poor coverage of 5G, different beams are transmitted in different directions, and a complete coverage of a cell is achieved through the transmission of multiple beams. The public information (e.g., paging and system broadcasting, etc.) and public signals (e.g., synchronization signal blocks (SSBs)) transmitted by the network side are transmitted as multiple instances over the air interface, that is, they are transmitted per beam. Terminal devices receive the public information and the public signals on corresponding beams at different geographical locations.

In 5G NR, there is an association relationship between random access resources and beams (i.e., different SSBs) in different directions. The network side identifies a best downlink beam for the terminal device based on random access resources (including the preamble and the random access occasion (RO)). Based on a beam correspondence, an uplink beam direction is determined according to the downlink beam direction.

During an initial access process in 5G NR, the network side can only distinguish which beam the terminal device is under, and cannot identify whether the terminal device is located at the center of the cell or at the edge of the cell. In this case, for downlink scheduling during the initial access process, the network side cannot obtain sufficient information, such as power headroom report (PHR), etc., and therefore cannot perform effective scheduling, including channel coding, a modulation scheme, and a number of repetitions, etc.

Furthermore, a size of MSG3 is related to coverage. During the LTE phase, the size of MSG3 is limited to within 56 bits. However, for a radio resource control (RRC) resume scenario, it is necessary to expand the size of MSG3 to 72 bits. Increasing the size of MSG3 to 72 bits would result in a coverage loss of 0.6 dB, and reducing coverage means that new stations must be added to compensate for the coverage, which increases network construction costs. An RRC resume request (RRCResumeRequest) message using a 40-bit initial radio network temporary identifier (I-RNTI) would require an MSG3 size of 72 bits, whereas using a 24-bit truncated I-RNTI would prevent a target base station from addressing an anchor base station. To address this issue, two types of I-RNTI are introduced: a 40-bit I-RNTI and a 24-bit truncated I-RNTI. The network side indicates through system broadcast (i.e., system information block 1 (SIB1)) whether the use of a 40-bit I-RNTI to initiate the RRC resume process is allowed. Specifically, useFullResumeID may be used for indicating whether the use of the 40-bit I-RNTI to initiate the RRC resume process is allowed.

In view of above, a beam-based cell may effectively meet coverage requirements. However, a beam distribution in the cell has limitations, which may result in terminal devices located in different areas of the cell being within a coverage area of a same beam. For example, terminal devices located at the center of the cell and those at the edge of the cell may be within the coverage area of the same beam. However, the coverage strength for terminal devices in different areas varies, with terminal devices closer to the center of the cell generally receiving stronger coverage and those farther from the center of the cell receiving weaker coverage. The network side generally identifies a location of a terminal device based on a beam used by the terminal device, which results in the network side being unable to more accurately identify the area where the terminal device is located. In future mobile communication systems (e.g., 6G), types of terminal devices are diverse, and it is beneficial for the performance of initial access that the network side identifies the area where the terminal device is located (e.g., distinguishing whether the terminal device is at the edge of the cell or the center of the cell) during the initial access process. Therefore, the following technical solutions are proposed in the embodiments of the disclosure.

It should be noted that the technical solutions in the embodiments of the disclosure may be applied to mobile communication systems such as 5G, enhanced 5G, and 6G, etc.

It should be noted that “beam layer” in the embodiments of the disclosure may also be referred to as “beam group”.

To facilitate understanding of the technical solutions in the embodiments of the disclosure, the technical solutions of the disclosure is described in detail below through specific embodiments. The above related technologies, as optional solutions, may be combined arbitrarily with the technical solutions in the embodiments of the disclosure, and all such combinations fall within the scope of protection of the embodiments of the disclosure. The embodiments of the disclosure include at least some of the following content.

When a station (e.g., a base station) performs beam scanning, multiple beam layers are scanned to achieve coverage of a cell, herein different beam layers correspond to different coverage areas of the cell. Beams in a beam layer may be regarded as beams scanned in two-dimension directions, and beams between beam layers may be regarded as beams scanned in another direction. In this way, beams scanned in three-dimension directions are achieved. It may be understood that the beam distribution achieved by multiple beam layers constitutes 3D beams.

FIG. 3 is a schematic diagram of a multiple beam layers-based cell according to an embodiment of the disclosure. Here, two beam layers are taken as an example for explanation. A first beam layer is a beam layer that is close to a center of the cell, which may be referred to as a cell center beam layer, and a second beam layer is a beam layer that is far from the center of the cell, which may be referred to as a cell edge beam layer. Coverage areas of the first beam layer and the second beam layer may overlap, as shown in (a) of FIG. 3. The coverage areas of the first beam layer and the second beam layer may not overlap, as shown in (b) of FIG. 3. It should be noted that in the case that the coverage areas of the first beam layer and the second beam layer overlap, it may include three cases: part coverage area of the first beam layer overlaps with part coverage area of the second beam layer, part coverage area of the first beam layer overlaps with entire coverage area of the second beam layer, and entire coverage area of the first beam layer overlaps with part coverage area of the second beam layer.

FIG. 4 is a schematic flowchart of a wireless communication method according to an embodiment of the disclosure. As shown in FIG. 4, the wireless communication method includes the following operation 401.

At operation 401, a terminal device performs initial access to a first cell, herein the first cell is covered by multiple beam layers, and different beam layers of the multiple beam layers correspond to different coverage areas within the first cell.

In an embodiment of the disclosure, a network device performs beam scanning to achieve coverage of the first cell through multiple beam layers, herein different beam layers of the multiple beam layers correspond to different coverage areas within the first cell.

In some embodiments, the network device is a station, e.g., a base station.

In some embodiments, the multiple beam layers in the first cell include a first beam layer and a second beam layer, and the first beam layer is closer to a center of the first cell compared to the second beam layer. Here, the first beam layer is a beam layer that is close to the center of the cell, which may be referred to as a cell center beam layer, and the second beam layer is a beam layer that is far from the center of the cell, which may be referred to as a cell edge beam layer.

In some embodiments, there are at least two beam layers among the multiple beam layers whose coverage areas overlap; and/or there are at least two beam layers among the multiple beam layers whose coverage areas do not overlap.

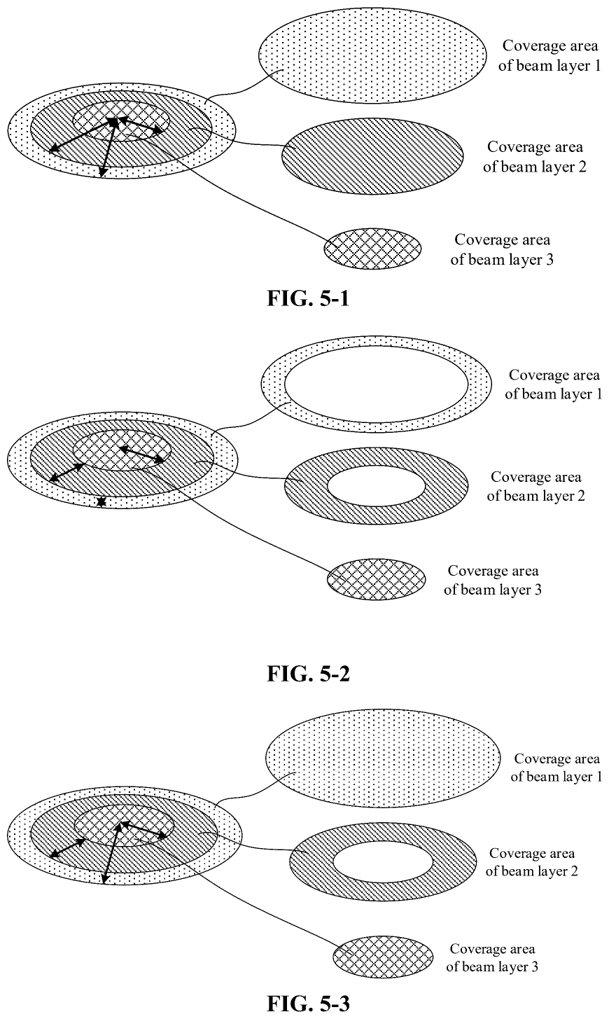

As an example: three beam layers are used for illustration. FIG. 5-2 shows a first schematic diagram of coverage areas of three beam layers, herein coverage areas of beam layer 1, beam layer 2, and beam layer 3 do not overlap with each other. FIG. 5-1 shows a second schematic diagram of coverage areas of three beam layers, herein part coverage area of beam layer 1 overlaps with entire coverage area of beam layer 2, and part coverage area of beam layer 2 overlaps with entire coverage area of beam layer 3. FIG. 5-3 shows a third schematic diagram of coverage areas of three beam layers, herein part coverage area of beam layer 1 overlaps with entire coverage area of beam layer 2, part coverage area of beam layer 1 overlaps with entire coverage area of beam layer 3, and coverage areas between beam layer 2 and beam layer 3 do not overlap.

In some embodiments, the multiple beam layers have at least one of the following features:

Different beam layers correspond to different beam inclination angles;

Different beam layers correspond to different horizontal beam widths;

Different beam layers correspond to different vertical beam widths;

Beams in a same beam layer correspond to a same beam inclination angle;

Beams in a same beam layer correspond to a same horizontal beam width; and

Beams in a same beam layer correspond to a same vertical beam width.

In some embodiments, different beam layers of the multiple beam layers use independent index spaces; and indices in each of the independent index spaces are used for numbering beams in each of the multiple beam layers.

Here, in a case where the different beam layers of the multiple beam layers use the independent index spaces, a beam is identified by a first index and a second index. The first index is an index of the beam in an independent index space, and the second index is an index of a beam layer to which the beam belongs among the multiple beam layers.

For example, a cell is covered by beam layer 1 and beam layer 2. Beam layer 1 includes beam 11, beam 12, and beam 13. Beam layer 2 includes beam 21, beam 22, and beam 23. Herein beam layer 1 and beam layer 2 use independent index spaces, and indices of beam 11, beam 12, and beam 13 are synchronization signal block (SSB) index0, SSB index1, and SSB index2, respectively. Indices of beam 21, beam 22, and beam 23 are SSB index0, SSB index1, and SSB index2, respectively. Beam 11 is identified by SSB index0 and an index (i.e., layer1) of beam layer 1, and the same applies to other beams.

In other embodiments, different beam layers of the multiple beam layers use a unified index space; and indices in the unified index space are used for numbering beams in the multiple beam layers. Here, the index space is an SSB index space.

Here, in a case where the different beam layers of the multiple beam layers use the unified index space, a beam is identified by a first index, herein the first index is an index of the beam in the unified index space.

For example, a cell is covered by beam layer 1 and beam layer 2. Beam layer 1 includes beam 11, beam 12, and beam 13. Beam layer 2 includes beam 21, beam 22, and beam 23. Herein beam layer 1 and beam layer 2 use a unified index space, and indices of beam 11, beam 12, and beam 13 are SSB index0, SSB index1, and SSB index2, respectively. Indices of beam 21, beam 22, and beam 23 are SSB index3, SSB index4, and SSB index5, respectively. Beam 11 is identified by SSB index0, and the same applies to other beams.

It should be noted that different SSBs are sent on different beams, and the beam number may be represented by the SSB index.

Cell stratification may be achieved through beam layers, that is, coverage areas of different beam layers correspond to different strata of the cell. This cell stratification is visible to both the terminal device and the network device. A number of beam layers of the cell may be two or more, depending on the implementation on the network side.

In some embodiments, the network device sends first configuration information and/or second configuration information to the terminal device, and the terminal device receives the first configuration information and/or the second configuration information sent by the network device. The first configuration information is used for configuring a number of beam layers included in the first cell, and the second configuration information is used for configuring SSB indices actually transmitted by each of the beam layers in the first cell. Here, the first configuration information and/or the second configuration information are carried in RRC signaling or system broadcasting.

Here, the network device may configure the number of beam layers included in the first cell. Furthermore, the network device may further configure which beams are included in each of the beam layers, i.e., configure SSB indices actually transmitted by each of the beam layers. Herein the SSB indices may be repeated in different beam layers, for example, SSB indices of beams in the first beam layer may be 0˜7, while SSB indices of beams in the second beam layer may also be 0˜7, that is, different beam layers use independent index spaces. Alternatively, the SSB indices may not be repeated in different beam layers, for example, SSB indices of beams in the first beam layer may be 0˜7, while SSB indices of beams in the second beam layer may be 8˜15, that is, different beam layers use a unified index space.

A total number of SSB indices actually transmitted in a cell is related to the band where frequency resources of the cell are located. In an example, the SSB indices actually transmitted in the cell may be configured through RRC signaling. In view of this, SSB indices actually transmitted by each of the beam layers in the first cell may be configured through RRC signaling, herein the SSB indices actually transmitted by each of the beam layers may be configured according to the contents shown in Table 1 below. Herein ssb-PositionsInBurst may be a bitmap, each bit in the bitmap corresponds to an SSB index, and a value of the bit is used for indicating whether an SSB index corresponding to the bit is an actual transmitted SSB index. For example, 1001 indicates that SSB index 0 and SSB index 3 are actual transmitted SSB indices.

TABLE 1

```
  ssb-PositionsInBurst SEQUENCE {
        inOneGroup BIT STRING (SIZE (8)),
        groupPresence BIT STRING (SIZE (8))
OPTIONAL -- Cond FR2-Only
    }
```

In some embodiments, the second configuration information is used for configuring SSB indices actually transmitted in the first cell according to a cell level, and for configuring a corresponding relationship between the SSB indices actually transmitted in the first cell and the beam layers. In this way, the terminal device may determine the SSB indices actually transmitted by each of the beam layers in the first cell.

Here, in the case where different beam layers of the multiple beam layers use the unified index space, corresponding actual transmitted SSB indices may be uniformly configured for the multiple beam layers (that is, the SSB indices actually transmitted in the first cell may be configured), and the network device needs to configure the corresponding relationship between the SSB indices actually transmitted in the first cell and the beam layers. In this way, the terminal device may determine the SSB indices actually transmitted by each of the beam layers in the first cell.

In other embodiments, the second configuration information is used for configuring the SSB indices actually transmitted by each of the beam layers in the first cell according to a beam layer level.

Here, in the case where different beam layers of the multiple beam layers use the independent index spaces, respective corresponding actual transmitted SSB indices may be configured respectively for each of the beam layers.

Based on the first cell based on the multiple beam layers, the terminal device performs the initial access to the first cell.

### Scheme One

In some embodiments, the terminal device selects a first beam in the first cell, and initiates a random access process to the first cell based on a first random access resource associated with the first beam. The first random access resource is used for indicating the first beam selected by the terminal device and/or a beam layer where the first beam is located.

Here, the random access resource includes preamble and/or RO resources.

Here, beams and random access resources have an associative relationship, and a beam may be associated with one or multiple random access resources. Based on this, the beam associated with the random access resource may be implicitly indicated through that resource.

For the network device, the network device receives the random access process initiated by the terminal device based on the first random access resource. The first random access resource is used for indicating the first beam selected by the terminal device and/or a beam layer where the first beam is located. In this way, the network device may determine the beam and/or the beam layer where the terminal device is located based on the first random access resource.

In some embodiments, the operation that the terminal device selects the first beam in the first cell includes that: the terminal device measures beams in the first cell; and the terminal device selects the first beam based on signal qualities of the measured beams and/or beam layers to which the beams belong.

In some embodiments, the operation that the terminal device selects the first beam based on the signal qualities of the measured beams and/or the beam layers to which the beams belong may be achieved through one of the following options:

Option 1) the terminal device selects a beam that belongs to a first beam layer and has a signal quality greater than or equal to a first threshold from the measured beams as the first beam.

Option 2) the terminal device selects a beam that belongs to the first beam layer and has a best signal quality from the measured beams as the first beam.

Option 3) the terminal device selects a beam that belongs to the first beam layer from the measured beams as the first beam.

Option 4) the terminal device selects a beam that has a signal quality greater than or equal to a second threshold from the measured beams as the first beam.

Option 5) the terminal device selects a beam that has a best signal quality from the measured beams as the first beam.

It should be noted that “signal quality of the beam” described in the embodiments of the disclosure refers to “signal quality of an SSB transmitted on the beam”. Herein the signal quality may be reference signal received power (RSRP) and/or reference signal received quality (RSRQ).

As an example: the cell includes two beam layers, namely a first beam layer and a second beam layer. The first beam layer is closer to the center of the first cell compared to the second beam layer. Here, the first beam layer is a beam layer close to the center of the cell, which may be referred to as a cell center beam layer, and the second beam layer is a beam layer far from the center of the cell, which may be referred to as a cell edge beam layer. If the terminal device detects a beam in the cell center beam layer, and RSRP and/or RSRQ of the beam is greater than a threshold configured by the network device, the terminal device prioritize selecting preamble and/or RO resources corresponding to the beam to initiate the random access process.

As an example: the cell includes two beam layers, namely a first beam layer and a second beam layer. The first beam layer is closer to the center of the first cell compared to the second beam layer. Here, the first beam layer is a beam layer close to the center of the cell, which may be referred to as a cell center beam layer, and the second beam layer is a beam layer far from the center of the cell, which may be referred to as a cell edge beam layer. Whether it is the first beam layer or the second beam layer, an SSB index of each of beams is associated with at least one preamble and/or RO. By receiving a preamble on an RO, the network device may determine a beam and/or a beam layer corresponding to the terminal device, thereby determining whether the terminal device is a cell center user (corresponding to the cell center beam layer) or a cell edge user (corresponding to the cell edge beam layer).

### Scheme Two

In some embodiments, the network device sends third configuration information to the terminal device, and the terminal device receives the third configuration information sent by the network device. The third configuration information is used for configuring at least one random access parameter used by each of beam layers in the first cell according to a beam layer level.

In some embodiments, the at least one random access parameter includes at least one of: preamble target received power (preambleReceivedTargetPower), a preamble power ramping step (powerRampingStep), a maximum number of preamble transmissions (preambleTransMax), a size of a random access response window (ra-ResponseWindow), a random access contention resolution timer (ra-ContenttionResolutionTimer), a maximum number of retransmissions for MSG3 (max-HARQ-Msg3Tx), and power offset of MSG3 relative to a last transmitted preamble.

Here, when the network device configures the at least one random access parameter (i.e., RACH parameter), some parameters may be configured according to a beam layer level. For example, the cell center beam layer and the cell edge beam layer are respectively configured with the following parameters: preambleReceivedTargetPower, preamble TransMax, powerRampingStep, ra-ResponseWindow, ra-ContentionResolutionTimer, and power offset of MSG3. It should be noted that the above parameters are only examples and are not limited to the above parameters.

As an example: both terminal devices located in the cell center beam layer and terminal devices located in the cell edge beam layer use a power ramping process during random access. However, a preamble power ramping step used by the terminal devices located in the cell center beam layer may be configured differently from a preamble power ramping step used by the terminal devices located in the cell edge beam layer. For example, the preamble power ramping step used by the terminal devices located in the cell center beam layer is smaller, and the preamble power ramping step used by the terminal devices located in the cell edge beam layer is larger.

As an example: the power offset of MSG3 is an offset value between uplink transmission power of a last preamble sent by the terminal device and power for sending MSG3. The power offset of MSG3 used by terminal devices located in the cell center beam layer may be configured differently from the power offset of MSG3 used by terminal devices located in the cell edge beam layer. For example, the power offset of MSG3 used by the terminal devices located in the cell center beam layer is smaller, and the power offset of MSG3 used by the terminal devices located in the cell edge beam layer is larger.

### Scheme Three

In some embodiments, the network device sends fourth configuration information to the terminal device, and the terminal device receives the fourth configuration information sent by the network device. The fourth configuration information is used for configuring at least one uplink transmission parameter and/or at least one downlink reception parameter used by each of beam layers in the first cell according to a beam layer level.

In some embodiments, the at least one uplink transmission parameter includes at least one of: a channel coding rate, a modulation scheme, and a number of repeated transmissions.

In some embodiments, the at least one downlink reception parameter includes at least one of: a channel decoding rate, and a demodulation scheme.

As an example: the cell includes two beam layers, namely a first beam layer and a second beam layer. The first beam layer is closer to the center of the first cell compared to the second beam layer. Here, the first beam layer is a beam layer close to the center of the cell, which may be referred to as a cell center beam layer, and the second beam layer is a beam layer far from the center of the cell, which may be referred to as a cell edge beam layer. During the initial access process, the network device may determine whether the terminal device is within the coverage area of the first beam layer (i.e., at the center of the cell) or within the coverage area of the second beam layer (i.e., at the edge of the cell) by a beam used by the terminal device during the random access process, thereby configuring different uplink transmission parameters and/or downlink reception parameters for terminal devices located in different beam layers. For example, for terminal devices located within the coverage area of the second beam layer (i.e., at the edge of the cell), the network device may improve uplink coverage and downlink coverage through effective scheduling and measures, such as improving the uplink coverage though reducing channel coding efficiency, using low-order modulation schemes, and increasing a number of repetitions, etc. For example, for terminal devices located within the coverage area of the first beam layer (i.e., at the center of the cell), for uplink transmission, the network device may use high-order modulation to improve spectral efficiency; and for downlink reception, the network device may use high-order modulation to improve spectral efficiency, and the network device may further use directional antennas, such as specific downlink beam directions, to further improve downlink coverage.

### Scheme Four

In some embodiments, the network device sends first indication information to the terminal device, and the terminal device receives the first indication information sent by the network device. The first indication information is used for indicating whether the first cell allows terminal devices to use a random access message of a first size, or for indicating whether the first cell allows terminal devices located within a coverage area of a first beam layer to use the random access message of the first size, or for indicating beam layers that the first cell allows terminal devices to use the random access message of the first size, or for indicating a maximum or minimum beam layer index that the first cell allows terminal devices to use the random access message of the first size, or for indicating a boundary beam layer index that the first cell allows terminal devices to use the random access message of the first size.

In some embodiments, the terminal device measures beams in the first cell; and if there is a beam that belongs to a first beam layer and/or has a signal quality greater than or equal to a third threshold in the beams measured by the terminal device, or if a signal quality of the first cell measured by the terminal device is greater than or equal to a fourth threshold, the terminal device determines that a random access message of a first size is capable of being used; otherwise, the terminal device determines that the random access message of the first size is not capable of being used.

Here, the random access message is, for example, MSG3 in the 4-step random access process or physical uplink shared channel (PUSCH) in MSG2 in the 2-step random access process.

Here, the first size is, for example, 72 bits.

In an example, the cell includes two beam layers, namely a first beam layer and a second beam layer. The first beam layer is closer to the center of the first cell compared to the second beam layer. Here, the first beam layer is a beam layer close to the center of the cell, which may be referred to as a cell center beam layer, and the second beam layer is a beam layer far from the center of the cell, which may be referred to as a cell edge beam layer. In the initial access process, if the terminal device is within the coverage area of the first beam layer (i.e., at the center of the cell), a large-size MSG3 may be used. Otherwise, a normal-size MSG3 needs to be used. The system broadcast of the cell may include a piece of indication information, which is used for indicating whether the cell allows terminal devices located within the coverage area of the first beam layer (i.e., at the center of the cell) to send a large-size MSG3. Here, the large-size MSG3 may be a 72-bit MSG3, and the normal-size MSG3 may be a 56-bit MSG3. This indication may be explicit or implicit.

In a scenario, the cell is a traditional cell, and a threshold, such as an RSRP and/or RSRQ threshold, is configured in the system broadcast of the cell. If the signal quality of the cell measured by the terminal device is greater than or equal to that threshold, it indicates that the terminal device is in the center area of the cell, and the terminal device may send a large-size MSG3. Otherwise, the terminal device cannot send a large-size MSG3.

In another scenario, the cell is based on multiple beam layers, and the system broadcast of the cell indicates which SSB indices correspond to beams in the cell center beam layer. If a signal quality of any beam in the cell center beam layer measured by the terminal device is greater than or equal to a threshold configured by the network device, it indicates that the terminal device is in the center area of the cell, and the terminal device may send a large-size MSG3. Otherwise, the terminal device cannot send a large-size MSG3.

### Scheme Five

In scenarios of a multiple beam layers-based cell, how to measure the signal quality of the cell needs to be redefined. It needs to be clarified whether the signal quality of the cell is determined based on measurement results of all beams in the cell or based on measurement results of some of the beam layers in the cell.

In some embodiments, the terminal device measures signal qualities of beams of a first beam layer in the first cell; and the terminal device determines a signal quality of the first cell based on the signal qualities of the beams of the first beam layer. Furthermore, if the signal qualities of the beams of the first beam layer or the signal quality of the first cell are less than and/or equal to a fifth threshold, the terminal device initiates a neighboring cell measurement or a measurement of a second beam layer.

Here, the operations that the terminal device measures the signal qualities of the beams of the first beam layer in the first cell; and the terminal device determines the signal quality of the first cell based on the signal qualities of the beams of the first beam layer may be achieved through any of the following options:

Option 1) the terminal device measures the signal qualities of the beams of the first beam layer in the first cell; and takes a signal quality of a beam that has a best signal quality as the signal quality of the first cell.

Option 2) the terminal device measures the signal qualities of the beams of the first beam layer in the first cell; and takes an offline average value of signal qualities of n beams that have signal qualities greater than or equal to a threshold as the signal quality of the first cell. Here, the threshold and n are configured through system broadcast.

In an example, the cell includes two beam layers, namely a first beam layer and a second beam layer. The first beam layer is closer to the center of the first cell compared to the second beam layer. Here, the first beam layer is a beam layer close to the center of the cell, which may be referred to as a cell center beam layer, and the second beam layer is a beam layer far from the center of the cell, which may be referred to as a cell edge beam layer. During a cell reselection measurement, the neighboring cell measurement or the measurement of the second beam layer may only be initiated if and only if the measurement result of the first beam layer or the cell measurement result obtained based on the measurement result of the first beam layer is below a certain threshold. Here, the measurement result refers to a measured signal quality, such as RSRP and/or RSRQ.

In some embodiments, the terminal device measures signal qualities of beams of a second beam layer in the first cell; and the terminal device determines a signal quality of the first cell based on the signal qualities of the beams of the second beam layer. Furthermore, if the signal qualities of the beams of the second beam layer or the signal quality of the first cell are less than and/or equal to a sixth threshold, the terminal device initiates a neighbor cell measurement.

Here, the operations that the terminal device measures the signal qualities of the beams of the second beam layer in the first cell; and the terminal device determines the signal quality of the first cell based on the signal qualities of the beams of the second beam layer may be achieved through any of the following options:

Option 1) the terminal device measures the signal qualities of the beams of the second beam layer in the first cell; and takes a signal quality of a beam that has a best signal quality as the signal quality of the first cell.

Option 2) the terminal device measures the signal qualities of the beams of the second beam layer in the first cell; and takes an offline average value of signal qualities of m beams that have signal qualities greater than or equal to a threshold as the signal quality of the first cell. Here, the threshold and m are configured through system broadcast.

In an example, the cell includes two beam layers, namely a first beam layer and a second beam layer. The first beam layer is closer to the center of the first cell compared to the second beam layer. Here, the first beam layer is a beam layer close to the center of the cell, which may be referred to as a cell center beam layer, and the second beam layer is a beam layer far from the center of the cell, which may be referred to as a cell edge beam layer. During a cell reselection measurement, the neighboring cell measurement may only be initiated if and only if the measurement result of the second beam layer or the cell measurement result obtained based on the measurement result of the second beam layer is below a certain threshold. Here, the measurement result refers to a measured signal quality, such as RSRP and/or RSRQ.

It should be noted that each of the above schemes in the embodiments of the disclosure may be implemented separately or in any combination.

The preferred embodiments of the disclosure are described in detail above with reference to the drawings. However, the disclosure is not limited to the specific details of the embodiments described above. Within the scope of the technical concept of the disclosure, various simple variations may be made to the technical solutions of the disclosure, and all these simple variations are within the scope of protection of the disclosure. For example, the specific technical features described in the above embodiments may be combined in any appropriate way without contradiction. In order to avoid unnecessary repetition, the disclosure does not further elaborate on various possible combinations. For another example, various different embodiments of the disclosure may also be combined arbitrarily, as long as they do not contradict the idea of the disclosure, they should also be regarded as the content disclosed by the disclosure. For yet another example, under the premise of no conflict, the various embodiments and/or technical features in the various embodiments described in the disclosure may be combined arbitrarily with the related art, and technical solutions obtained after such combinations should also fall within the scope of protection of the disclosure.

It should further be understood that in the various method embodiments of the disclosure, the order of sequence numbers for the above processes does not imply the order of execution. The order of execution of each of the processes should be determined based on its function and inherent logic, and should not constitute any limitation on the implementation process of the embodiments of the disclosure. Furthermore, in the embodiments of the disclosure, terms “downlink”, “uplink”, and “sidelink” are used for indicating the transmission direction of signals or data, herein “downlink” is used for indicating that the transmission direction of signals or data is a first direction sent from the station to the user device in the cell, “uplink” is used for indicating that the transmission direction of signals or data is a second direction sent from the user device in the cell to the station, and “sidelink” is used for indicating that the transmission direction of signals or data is a third direction sent from user device 1 to user device 2. For example, “downlink signal” indicates that the transmission direction of the signal is the first direction. Furthermore, in the embodiments of the disclosure, a term “and/or” is only an association relationship describing associated objects, and indicates that there may be three relationships. Specifically, A and/or B may indicate three cases: existence of A alone, existence of A and B simultaneously, and existence of B alone. Furthermore, a character “/” in the disclosure generally indicates that preceding and following associated objects are in an “or” relationship.

FIG. 6 is a first schematic diagram of a structure of a wireless communication apparatus according to an embodiment of the disclosure, applied to a terminal device. As shown in FIG. 6, the wireless communication apparatus includes a communication unit 601.

The communication unit 601 is configured to perform initial access to a first cell, herein the first cell is covered by multiple beam layers, and different beam layers of the multiple beam layers correspond to different coverage areas within the first cell.

In some embodiments, the multiple beam layers have at least one of the following features:

Different beam layers correspond to different beam inclination angles;

Different beam layers correspond to different horizontal beam widths;

Different beam layers correspond to different vertical beam widths;

Beams in a same beam layer correspond to a same beam inclination angle;

Beams in a same beam layer correspond to a same horizontal beam width; and

Beams in a same beam layer correspond to a same vertical beam width.

In some embodiments, there are at least two beam layers among the multiple beam layers whose coverage areas overlap; and/or there are at least two beam layers among the multiple beam layers whose coverage areas do not overlap.

In some embodiments, different beam layers of the multiple beam layers use independent index spaces; or different beam layers of the multiple beam layers use a unified index space.

Indices in the independent index spaces or the unified index space are used for numbering beams in the multiple beam layers.

In some embodiments, in a case where the different beam layers of the multiple beam layers use the independent index spaces, a beam is identified by a first index and a second index, herein the first index is an index of the beam in an independent index space, and the second index is an index of a beam layer to which the beam belongs among the multiple beam layers.

In some embodiments, in a case where the different beam layers of the multiple beam layers use the unified index space, a beam is identified by a first index, herein the first index is an index of the beam in the unified index space.

In some embodiments, the independent index spaces and the unified index space are synchronization signal block (SSB) index spaces.

In some embodiments, the communication unit 601 is configured to receive first configuration information and/or second configuration information sent by a network device, herein the first configuration information is used for configuring a number of beam layers included in the first cell, and the second configuration information is used for configuring synchronization signal block (SSB) indices actually transmitted by each of the beam layers in the first cell.

In some embodiments, the second configuration information is used for configuring SSB indices actually transmitted in the first cell according to a cell level, and for configuring a corresponding relationship between the SSB indices actually transmitted in the first cell and the beam layers; or the second configuration information is used for configuring the SSB indices actually transmitted by each of the beam layers in the first cell according to a beam layer level.

In some embodiments, the apparatus further includes a processing unit 602 configured to select a first beam in the first cell.

The communication unit 601 is configured to initiate a random access process to the first cell based on a first random access resource associated with the first beam. The first random access resource is used for indicating the first beam selected by the terminal device and/or a beam layer where the first beam is located.

In some embodiments, the communication unit 601 is configured to measure beams in the first cell. The processing unit 602 is configured to select the first beam based on signal qualities of the measured beams and/or beam layers to which the beams belong.

In some embodiments, the processing unit 602 is configured to select a beam that belongs to a first beam layer and has a signal quality greater than or equal to a first threshold from the measured beams as the first beam; or select a beam that belongs to the first beam layer and has a best signal quality from the measured beams as the first beam; or select a beam that belongs to the first beam layer from the measured beams as the first beam; or select a beam that has a signal quality greater than or equal to a second threshold from the measured beams as the first beam; or select a beam that has a best signal quality from the measured beams as the first beam.

In some embodiments, the communication unit 601 is configured to receive third configuration information sent by a network device. The third configuration information is used for configuring at least one random access parameter used by each of beam layers in the first cell according to a beam layer level.

In some embodiments, the at least one random access parameter includes at least one of: preamble target received power, a preamble power ramping step, a maximum number of preamble transmissions, a size of a random access response window, a random access contention resolution timer, a maximum number of retransmissions for MSG3, and power offset of MSG3 relative to a last transmitted preamble.

In some embodiments, the communication unit 601 is configured to receive fourth configuration information sent by a network device. The fourth configuration information is used for configuring at least one uplink transmission parameter and/or at least one downlink reception parameter used by each of beam layers in the first cell according to a beam layer level.

In some embodiments, the at least one uplink transmission parameter includes at least one of: a channel coding rate, a modulation scheme, and a number of repeated transmissions.

In some embodiments, the at least one downlink reception parameter includes at least one of: a channel decoding rate, and a demodulation scheme.

In some embodiments, the communication unit 601 is configured to receive first indication information sent by a network device. The first indication information is used for indicating whether the first cell allows terminal devices to use a random access message of a first size, or for indicating whether the first cell allows terminal devices located within a coverage area of a first beam layer to use the random access message of the first size, or for indicating beam layers that the first cell allows terminal devices to use the random access message of the first size, or for indicating a maximum or minimum beam layer index that the first cell allows terminal devices to use the random access message of the first size, or for indicating a boundary beam layer index that the first cell allows terminal devices to use the random access message of the first size.

In some embodiments, the communication unit 601 is configured to measure beams in the first cell.

The processing unit 602 is configured to determine that a random access message of a first size is capable of being used if there is a beam that belongs to a first beam layer and/or has a signal quality greater than or equal to a third threshold in the measured beams, or if a measured signal quality of the first cell is greater than or equal to a fourth threshold; otherwise, the processing unit 602 is configured to determine that the random access message of the first size is not capable of being used.

In some embodiments, the communication unit 601 is configured to measure signal qualities of beams of a first beam layer in the first cell.

The processing unit 602 is configured to determine a signal quality of the first cell based on the signal qualities of the beams of the first beam layer.

In some embodiments, the communication unit 601 is configured to initiate a neighboring cell measurement or a measurement of a second beam layer if the signal qualities of the beams of the first beam layer or the signal quality of the first cell are less than and/or equal to a fifth threshold.

In some embodiments, the communication unit 601 is configured to measure signal qualities of beams of a second beam layer in the first cell.

The processing unit 602 is configured to determine a signal quality of the first cell based on the signal qualities of the beams of the second beam layer.

In some embodiments, the communication unit 601 is configured to initiate a neighbor cell measurement if the signal qualities of the beams of the second beam layer or the signal quality of the first cell are less than and/or equal to a sixth threshold.

In some embodiments, the multiple beam layers in the first cell include a first beam layer and a second beam layer, and the first beam layer is closer to a center of the first cell compared to the second beam layer.

It should be understood by those skilled in the art that the related description of the wireless communication apparatus in the embodiments of the disclosure may be understood with reference to the related description of the wireless communication method in the embodiments of the disclosure.

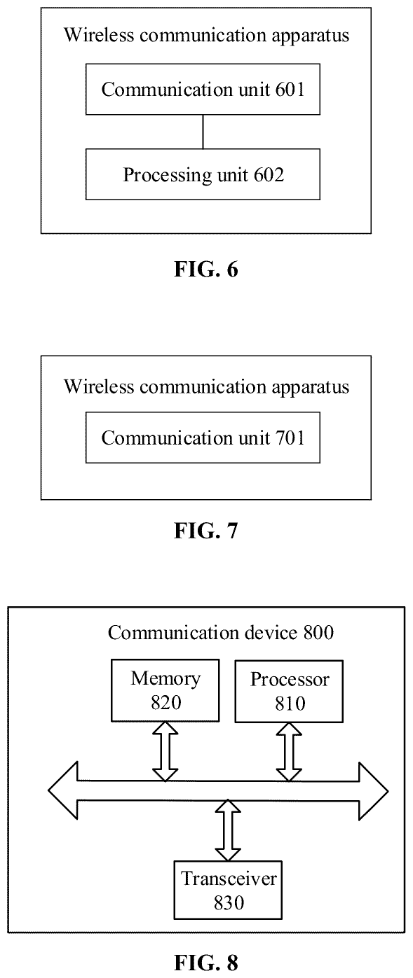

FIG. 7 is a second schematic diagram of a structure of a wireless communication apparatus according to an embodiment of the disclosure, applied to a network device. As shown in FIG. 7, the wireless communication apparatus includes a communication unit 701.

The communication unit 701 is configured to perform beam scanning to achieve coverage of a first cell through multiple beam layers, herein different beam layers of the multiple beam layers correspond to different coverage areas within the first cell.

In some embodiments, the multiple beam layers have at least one of the following features:

Different beam layers correspond to different beam inclination angles;

Different beam layers correspond to different horizontal beam widths;

Different beam layers correspond to different vertical beam widths;

Beams in a same beam layer correspond to a same beam inclination angle;

Beams in a same beam layer correspond to a same horizontal beam width; and

Beams in a same beam layer correspond to a same vertical beam width.

In some embodiments, there are at least two beam layers among the multiple beam layers whose coverage areas overlap; and/or there are at least two beam layers among the multiple beam layers whose coverage areas do not overlap.

In some embodiments, different beam layers of the multiple beam layers use independent index spaces; or different beam layers of the multiple beam layers use a unified index space.

Indices in the independent index spaces or the unified index space are used for numbering beams in the multiple beam layers.

In some embodiments, in a case where the different beam layers of the multiple beam layers use the independent index spaces, a beam is identified by a first index and a second index, herein the first index is an index of the beam in an independent index space, and the second index is an index of a beam layer to which the beam belongs among the multiple beam layers.

In some embodiments, in a case where the different beam layers of the multiple beam layers use the unified index space, a beam is identified by a first index, herein the first index is an index of the beam in the unified index space.

In some embodiments, the independent index spaces and the unified index space are synchronization signal block (SSB) index spaces.

In some embodiments, the communication unit 701 is configured to send first configuration information and/or second configuration information to a terminal device, herein the first configuration information is used for configuring a number of beam layers included in the first cell, and the second configuration information is used for configuring synchronization signal block (SSB) indices actually transmitted by each of the beam layers in the first cell.

In some embodiments, the second configuration information is used for configuring SSB indices actually transmitted in the first cell according to a cell level, and for configuring a corresponding relationship between the SSB indices actually transmitted in the first cell and the beam layers; or the second configuration information is used for configuring the SSB indices actually transmitted by each of the beam layers in the first cell according to a beam layer level.

In some embodiments, the communication unit 701 is configured to receive a random access process initiated by a terminal device based on a first random access resource; herein the first random access resource is used for indicating a first beam selected by the terminal device and/or a beam layer where the first beam is located.

In some embodiments, the communication unit 701 is configured to send third configuration information to a terminal device. The third configuration information is used for configuring at least one random access parameter used by each of beam layers in the first cell according to a beam layer level.

In some embodiments, the at least one random access parameter includes at least one of: preamble target received power, a preamble power ramping step, a maximum number of preamble transmissions, a size of a random access response window, a random access contention resolution timer, a maximum number of retransmissions for MSG3, and power offset of MSG3 relative to a last transmitted preamble.

In some embodiments, the communication unit 701 is configured to send fourth configuration information to a terminal device. The fourth configuration information is used for configuring at least one uplink transmission parameter and/or at least one downlink reception parameter used by each of beam layers in the first cell according to a beam layer level.

In some embodiments, the at least one uplink transmission parameter includes at least one of: a channel coding rate, a modulation scheme, and a number of repeated transmissions.

In some embodiments, the at least one downlink reception parameter includes at least one of: a channel decoding rate, and a demodulation scheme.

In some embodiments, the communication unit 701 is configured to send first indication information to a terminal device. The first indication information is used for indicating whether the first cell allows terminal devices to use a random access message of a first size, or for indicating whether the first cell allows terminal devices located within a coverage area of a first beam layer to use the random access message of the first size, or for indicating beam layers that the first cell allows terminal devices to use the random access message of the first size, or for indicating a maximum or minimum beam layer index that the first cell allows terminal devices to use the random access message of the first size, or for indicating a boundary beam layer index that the first cell allows terminal devices to use the random access message of the first size.

In some embodiments, the multiple beam layers in the first cell include a first beam layer and a second beam layer, and the first beam layer is closer to a center of the first cell compared to the second beam layer.

It should be understood by those skilled in the art that the related description of the wireless communication apparatus in the embodiments of the disclosure may be understood with reference to the related description of the wireless communication method in the embodiments of the disclosure.

Through the technical solutions described above, a new beam distribution model is proposed. Specifically, a cell is covered by multiple beam layers, and different beam layers of the multiple beam layers correspond to different coverage areas within the cell. Since beams in a beam layer may be regarded as beams scanned in two-dimension directions, and beams between beam layers may be regarded as beams scanned in another direction, beams scanned in three-dimension directions (i.e., 3D beams) are achieved, and the beam distribution is more flexible. The network side may identify the area where the terminal device is located more accurately based on the 3D beams, thereby providing a basis for ensuring different wireless resources for terminal devices in different areas and improving wireless communication performance.

FIG. 8 is a schematic structural diagram of a communication device 800 according to an embodiment of the disclosure. The communication device may be a terminal device or a network device. The communication device 800 shown in FIG. 8 includes a processor 810, which may call and run a computer program from a memory to implement the method in the embodiments of the disclosure.

Optionally, as shown in FIG. 8, the communication device 800 may further include a memory 820. Herein the processor 810 may call and run a computer program from the memory 820 to implement the method in the embodiments of the disclosure.

Herein the memory 820 may be a separate device independent of the processor 810, or may be integrated in the processor 810.

Optionally, as shown in FIG. 8, the communication device 800 may further include a transceiver 830, and the processor 810 may control the transceiver 830 to communicate with other devices. Specifically, the transceiver 830 may send information or data to other devices, or may receive information or data sent by other devices.

Herein the transceiver 830 may include a transmitter and a receiver. The transceiver 830 may further include one or more antennas.

Optionally, the communication device 800 may specifically be the network device in the embodiments of the disclosure, and the communication device 800 may implement the corresponding processes implemented by the network device in various methods in the embodiments of the disclosure, which is not be repeated here for the sake of brevity.

Optionally, the communication device 800 may specifically be the mobile terminal/terminal device in the embodiments of the disclosure, and the communication device 800 may implement the corresponding processes implemented by the mobile terminal/terminal device in various methods in the embodiments of the disclosure, which is not be repeated here for the sake of brevity.

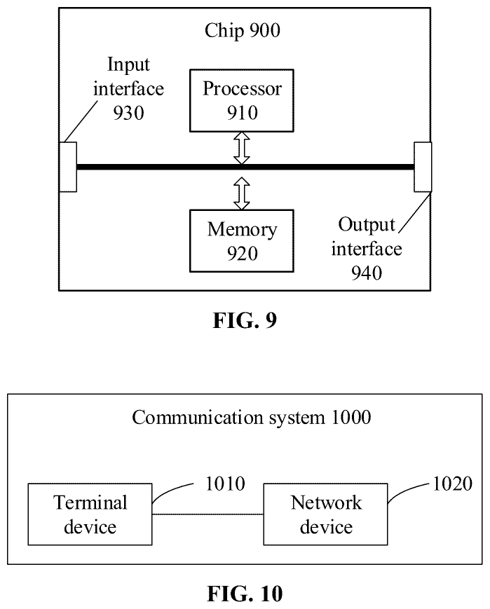

FIG. 9 is a schematic structural diagram of a chip according to an embodiment of the disclosure. The chip 900 shown in FIG. 9 includes a processor 910, which may call and run a computer program from a memory to implement the method in the embodiments of the disclosure.

Optionally, as shown in FIG. 9, the chip 900 may further include a memory 920. The processor 910 may call and run a computer program from the memory 920 to implement the method in the embodiments of the disclosure.

Herein the memory 920 may be a separate device independent of the processor 910, or may be integrated in the processor 910.

Optionally, the chip 900 may further include an input interface 930. The processor 910 may control the input interface 930 to communicate with other devices or chips. Specifically, the input interface 930 may obtain information or data sent by other devices or chips.

Optionally, the chip 900 may further include an output interface 940. The processor 910 may control the output interface 940 to communicate with other devices or chips. Specifically, the output interface 940 may output information or data to other devices or chips.

Optionally, the chip may be applied to the network device in the embodiments of the disclosure, and the chip may implement the corresponding processes implemented by the network device in various methods in the embodiments of the disclosure, which is not be repeated here for the sake of brevity.

Optionally, the chip may be applied to the mobile terminal/terminal device in the embodiments of the disclosure, and the chip may implement the corresponding processes implemented by the mobile terminal/terminal device in various methods in the embodiments of the disclosure, which is not be repeated here for the sake of brevity.

It should be understood that the chip mentioned in the embodiments of the disclosure may also be referred to as a system on chip, a system chip, a chip system, or a system on chip, etc.

FIG. 10 is a schematic block diagram of a communication system 1000 according to an embodiment of the disclosure. As shown in FIG. 10, the communication system 1000 includes a terminal device 1010 and a network device 1020.

Herein the terminal device 1010 may be configured to implement the corresponding functions implemented by the terminal device in the above method, and the network device 1020 may be configured to implement the corresponding functions implemented by the network device in the above method, which is not be repeated here for the sake of brevity.

It should be understood that the processor in the embodiments of the disclosure may be an integrated circuit chip having signal processing capability. In the implementation process, each operation of the above method embodiments may be accomplished by an integrated logic circuit of hardware or by an instruction in form of software in the processor. The above processor may be a general purpose processor, a Digital Signal Processor (DSP), an Application Specific Integrated Circuit (ASIC), a Field Programmable Gate Array (FPGA), or other programmable logic device, discrete gate or transistor logic device, discrete hardware component. The processor may implement or perform the methods, operations, and logical block diagrams disclosed in the embodiments of the disclosure. The general purpose processor may be a microprocessor or any conventional processor or the like. The operations of the methods disclosed in the embodiments of the disclosure may be directly accomplished by the hardware decoding processor, or be accomplished by a combination of hardware and software modules in the decoding processor. The software module may be located in a Random Access Memory (RAM), a flash memory, a Read-Only Memory (ROM), a Programmable ROM (PROM) or an Electrically Erasable PROM (EEPROM), a register and other storage medium mature in the art. The storage medium is located in the memory, and the processor reads information in the memory to implement the operations of the methods above in combination with the hardware.

It may be understood that the memory in the embodiments of the disclosure may be a transitory memory or a non-transitory memory, or may include both the transitory memory and the non-transitory memory. The non-transitory memory may be a ROM, a PROM, an Erasable PROM (EPROM), an EEPROM, or a flash memory. The transitory memory may be a RAM that used as an external cache. By way of illustration but not limitation, many forms of RAMs may be available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It should be noted that the memories of the systems and methods described herein are intended to include, but are not limited to, these and any other suitable types of memories.

It should be understood that the above memory is an example but not a limiting description. For example, the memory in the embodiments of the disclosure may also be a SRAM, a DRAM, a SDRAM, a DDR SDRAM, an ESDRAM, a SLDRAM, a DR RAM, and the like. That is, the memories in the embodiments of the disclosure are intended to include, but are not limited to, these and any other suitable types of memories.

A computer-readable storage medium configured to store a computer program is further provided according to an embodiment of the disclosure.

Optionally, the computer-readable storage medium may be applied to the network device in the embodiments of the disclosure, and the computer program enables the computer to execute the corresponding processes implemented by the network device in the various methods in the embodiments of the disclosure, which is not be repeated here for the sake of brevity.

Optionally, the computer-readable storage medium may be applied to the mobile terminal/terminal device in the embodiments of the disclosure, and the computer program enables the computer to execute the corresponding processes implemented by the mobile terminal/terminal device in the various methods in the embodiments of the disclosure, which is not be repeated here for the sake of brevity.

A computer program product including a computer program instruction is further provided according to an embodiment of the disclosure.

Optionally, the computer program product may be applied to the network device in the embodiments of the disclosure, and the computer program instruction causes the computer to execute the corresponding processes implemented by the network device in the various methods in the embodiments of the disclosure, which is not be repeated here for the sake of brevity.

Optionally, the computer program product may be applied to the mobile terminal/terminal device in the embodiments of the disclosure, and the computer program instruction causes the computer to execute the corresponding processes implemented by the mobile terminal/terminal device in the various methods in the embodiments of the disclosure, which is not be repeated here for the sake of brevity.

A computer program is further provided according to an embodiment of the disclosure.

Optionally, the computer program may be applied to the network device in the embodiments of the disclosure, and the computer program is run on a computer to enable the computer to execute the corresponding processes implemented by the network device in the various methods in the embodiments of the disclosure, which is not be repeated here for the sake of brevity.

Optionally, the computer program may be applied to the mobile terminal/terminal device in the embodiments of the disclosure, and the computer program is run on a computer to enable the computer to execute the corresponding processes implemented by the mobile terminal/terminal device in the various methods in the embodiments of the disclosure, which is not be repeated here for the sake of brevity.

It may be appreciated by those skilled in the art that the various example units and algorithm operations described in combination with the embodiments disclosed herein may be implemented in electronic hardware or a combination of computer software and electronic hardware. Whether these functions are performed in hardware or software depends on specific applications and design constraints of the technical scheme. Those skilled may use different methods for specific applications to implement the described functions, but such implementation should not be considered beyond the scope of the disclosure.

It may be clearly appreciated by those skilled in the art that for convenience and conciseness of description, regarding the specific operating processes of the systems, apparatuses and units above, reference may be made to the corresponding processes in the method embodiments above and are not be repeated herein.

In the several embodiments provided in the disclosure, it should be understood that the disclosed systems, apparatuses and methods may be implemented by other ways. For example, the apparatus embodiments above are only illustrative. For example, the division of the units is only a logical functional division, and in practice, there may be other division manners. For example, multiple units or components may be combined or integrated into another system, or some features may be ignored or not performed. On the other hand, the coupling or direct coupling or communication connection between the units and components illustrated or discussed may be indirect coupling or communication connection through some interfaces, apparatuses or units, and may be electrical, mechanical or other forms.

The units illustrated as separate components may or may not be physically separated, and the components displayed as units may or may not be physical units, i.e., the units and components may be located in one place, or may be distributed over multiple network units. A part or all of the units may be selected according to actual needs to achieve the objectives of the embodiments of the disclosure.

Furthermore, the functional units in the various embodiments of the disclosure may be integrated in one processing unit, or the units may exist physically individually, or two or more units may be integrated in one unit.

The functions may be stored in a computer-readable storage medium if the functions are implemented in form of software functional units and sold or used as stand-alone products. Based on such understanding, the essence of the technical solutions of the disclosure, or the part that contributes to the related art, or part of the technical solutions may be embodied in the form of a software product stored in a storage medium including several instructions, which to enable a computer device (which may be a personal computer, a server, or a network device, etc.) to implement all or part of the operations of the methods described in the various embodiments of the disclosure. The above storage medium includes a Universal Serial Bus (USB) flash drive, a removable hard disk, a Read-Only Memory (ROM), a Random Access Memory (RAM), a magnetic disk, an optical disk, or any other medium that may store program codes.

The descriptions above are merely specific embodiments of the disclosure, but the scope of protection of the disclosure is not limited thereto. Any change or replacement readily contemplated by a person skilled in the art within the technical scope disclosed in the disclosure shall fall within the scope of protection of the disclosure. Accordingly, the scope of protection of the disclosure shall be subject to the scope of protection of the claims.

1. A wireless communication method, comprising:
performing, by a terminal device, initial access to a first cell, wherein the first cell is covered by a plurality of beam layers, and different beam layers of the plurality of beam layers correspond to different coverage areas within the first cell.

2. The method of claim 1, wherein the plurality of beam layers comprise at least two beam layers whose coverage areas overlap; and/or
the plurality of beam layers comprise at least two beam layers whose coverage areas do not overlap.

3. The method of claim 1, wherein
different beam layers of the plurality of beam layers use independent index spaces; or
different beam layers of the plurality of beam layers use a unified index space,
wherein an index in the index space is used for numbering a beam in the plurality of beam layers,
wherein in a case where the different beam layers of the plurality of beam layers use the independent index spaces, a beam is identified by a first index and a second index, wherein the first index is an index of the beam in an independent index space, and the second index is an index of a beam layer, to which the beam belongs, in the plurality of beam layers,
wherein in a case where the different beam layers of the plurality of beam layers use the unified index space, a beam is identified by a first index, wherein the first index is an index of the beam in the index space,
wherein the index space is a synchronization signal block (SSB) index space.

4. The method of claim 1, further comprising:
receiving, by the terminal device, first configuration information and/or second configuration information sent by a network device, wherein the first configuration information is used for configuring a number of beam layers comprised in the first cell, and the second configuration information is used for configuring synchronization signal block (SSB) indices actually transmitted by each of the beam layers in the first cell,
wherein
the second configuration information is used for configuring SSB indices actually transmitted in the first cell according to a cell level, and for configuring a corresponding relationship between the SSB indices actually transmitted in the first cell and the beam layers; or
the second configuration information is used for configuring the SSB indices actually transmitted by each of the beam layers in the first cell according to a beam layer level.

5. The method of claim 1, wherein performing, by the terminal device, the initial access to the first cell comprises:
selecting, by the terminal device, a first beam in the first cell, and initiating a random access process to the first cell based on a first random access resource associated with the first beam; wherein the first random access resource is used for indicating the first beam selected by the terminal device and/or a beam layer where the first beam is located,
wherein selecting, by the terminal device, the first beam in the first cell comprises:
measuring, by the terminal device, beams in the first cell; and
selecting, by the terminal device, the first beam based on signal qualities of the measured beams and/or beam layers to which the beams belong,
wherein selecting, by the terminal device, the first beam based on the signal qualities of the measured beams and/or the beam layers to which the beams belong comprises:
selecting from the measured beams, by the terminal device, a beam that belongs to a first beam layer and has a signal quality greater than or equal to a first threshold as the first beam; or
selecting from the measured beams, by the terminal device, a beam that belongs to the first beam layer and has a best signal quality as the first beam; or
selecting from the measured beams, by the terminal device, a beam that belongs to the first beam layer as the first beam; or
selecting from the measured beams, by the terminal device, a beam that has a signal quality greater than and/or equal to a second threshold as the first beam; or
selecting from the measured beams, by the terminal device, a beam that has a best signal quality as the first beam.

6. The method of claim 1, further comprising:
receiving, by the terminal device, fourth configuration information sent by a network device, wherein the fourth configuration information is used for configuring an uplink transmission parameter and/or downlink reception parameter used by each of beam layers in the first cell according to a beam layer level,
receiving, by the terminal device, first indication information sent by a network device, wherein the first indication information is used for indicating whether the first cell allows terminal devices to use a random access message of a first size, or for indicating whether the first cell allows terminal devices located within a coverage area of a first beam layer to use the random access message of the first size, or for indicating beam layers that the first cell allows terminal devices to use the random access message of the first size, or for indicating a maximum or minimum beam layer index that the first cell allows terminal devices to use the random access message of the first size, or for indicating a boundary beam layer index that the first cell allows terminal devices to use the random access message of the first size.

7. The method of claim 1, wherein performing, by the terminal device, the initial access to the first cell comprises:
measuring, by the terminal device, beams in the first cell; and
if there is a beam that belongs to a first beam layer and/or has a signal quality greater than or equal to a third threshold in the beams measured by the terminal device, or if a signal quality of the first cell measured by the terminal device is greater than or equal to a fourth threshold, determining, by the terminal device, that a random access message of a first size is capable of being used; otherwise, determining, by the terminal device, that the random access message of the first size is not capable of being used,
wherein the method further comprises:
measuring, by the terminal device, signal qualities of beams of a first beam layer in the first cell;
determining, by the terminal device, a signal quality of the first cell based on the signal qualities of the beams of the first beam layer; and
if the signal qualities of the beams of the first beam layer or the signal quality based on the first cell are/is less than and/or equal to a fifth threshold, initiating, by the terminal device, a neighboring cell measurement or a measurement of a second beam layer,
and wherein the method further comprises:
measuring, by the terminal device, signal qualities of beams of a second beam layer in the first cell;
determining, by the terminal device, a signal quality of the first cell based on the signal qualities of the beams of the second beam layer; and
if the signal qualities of the beams of the second beam layer or the signal quality based on the first cell are/is less than and/or equal to a sixth threshold, initiating, by the terminal device, a neighbor cell measurement,
wherein the plurality of beam layers in the first cell comprise a first beam layer and a second beam layer, and the first beam layer is closer to a center of the first cell compared to the second beam layer.

8. A terminal device, comprising a processor and a memory, wherein the memory is configured to store a computer program, and the processor is configured to call and run the computer program stored in the memory to cause the terminal device to perform an operation of:
performing initial access to a first cell, wherein the first cell is covered by a plurality of beam layers, and different beam layers of the plurality of beam layers correspond to different coverage areas within the first cell.

9. The terminal device of claim 8, wherein the plurality of beam layers comprise at least two beam layers whose coverage areas overlap; and/or
the plurality of beam layers comprise at least two beam layers whose coverage areas do not overlap.

10. The terminal device of claim 8, wherein
different beam layers of the plurality of beam layers use independent index spaces; or
different beam layers of the plurality of beam layers use a unified index space,
wherein an index in the index space is used for numbering a beam in the plurality of beam layers,
wherein in a case where the different beam layers of the plurality of beam layers use the independent index spaces, a beam is identified by a first index and a second index, wherein the first index is an index of the beam in an independent index space, and the second index is an index of a beam layer, to which the beam belongs, in the plurality of beam layers,
wherein in a case where the different beam layers of the plurality of beam layers use the unified index space, a beam is identified by a first index, wherein the first index is an index of the beam in the index space,
wherein the index space is a synchronization signal block (SSB) index space.

11. The terminal device of claim 8, wherein the processor is further configured to call and run the computer program stored in the memory to cause the terminal device to perform an operation of:
receiving first configuration information and/or second configuration information sent by a network device, wherein the first configuration information is used for configuring a number of beam layers comprised in the first cell, and the second configuration information is used for configuring synchronization signal block (SSB) indices actually transmitted by each of the beam layers in the first cell,
wherein
the second configuration information is used for configuring SSB indices actually transmitted in the first cell according to a cell level, and for configuring a corresponding relationship between the SSB indices actually transmitted in the first cell and the beam layers; or
the second configuration information is used for configuring the SSB indices actually transmitted by each of the beam layers in the first cell according to a beam layer level.

12. The terminal device of claim 8, wherein the processor is further configured to call and run the computer program stored in the memory to cause the terminal device to perform an operation of performing the initial access to the first cell by:
selecting a first beam in the first cell, and initiating a random access process to the first cell based on a first random access resource associated with the first beam; wherein the first random access resource is used for indicating the first beam selected by the terminal device and/or a beam layer where the first beam is located,
wherein the processor is further configured to call and run the computer program stored in the memory to cause the terminal device to perform an operation of selecting the first beam in the first cell by:
measuring beams in the first cell; and
selecting the first beam based on signal qualities of the measured beams and/or beam layers to which the beams belong,
wherein the processor is further configured to call and run the computer program stored in the memory to cause the terminal device to perform an operation of selecting the first beam based on the signal qualities of the measured beams and/or the beam layers to which the beams belong by:
selecting from the measured beams a beam that belongs to a first beam layer and has a signal quality greater than or equal to a first threshold as the first beam; or
selecting from the measured beams a beam that belongs to the first beam layer and has a best signal quality as the first beam; or
selecting from the measured beams a beam that belongs to the first beam layer as the first beam; or
selecting from the measured beams a beam that has a signal quality greater than and/or equal to a second threshold as the first beam; or
selecting from the measured beams a beam that has a best signal quality as the first beam.

13. The terminal device of claim 8, wherein the processor is further configured to call and run the computer program stored in the memory to cause the terminal device to perform an operation of:
receiving fourth configuration information sent by a network device, wherein the fourth configuration information is used for configuring an uplink transmission parameter and/or downlink reception parameter used by each of beam layers in the first cell according to a beam layer level,
receiving first indication information sent by a network device, wherein the first indication information is used for indicating whether the first cell allows terminal devices to use a random access message of a first size, or for indicating whether the first cell allows terminal devices located within a coverage area of a first beam layer to use the random access message of the first size, or for indicating beam layers that the first cell allows terminal devices to use the random access message of the first size, or for indicating a maximum or minimum beam layer index that the first cell allows terminal devices to use the random access message of the first size, or for indicating a boundary beam layer index that the first cell allows terminal devices to use the random access message of the first size.

14. The terminal device of claim 8, wherein the processor is further configured to call and run the computer program stored in the memory to cause the terminal device to perform an operation of performing the initial access to the first cell by:
measuring beams in the first cell; and
if there is a beam that belongs to a first beam layer and/or has a signal quality greater than or equal to a third threshold in the beams measured by the terminal device, or if a signal quality of the first cell measured by the terminal device is greater than or equal to a fourth threshold, determining that a random access message of a first size is capable of being used; otherwise, determining that the random access message of the first size is not capable of being used,
wherein the processor is further configured to call and run the computer program stored in the memory to cause the terminal device to perform an operation of:
measuring signal qualities of beams of a first beam layer in the first cell;
determining a signal quality of the first cell based on the signal qualities of the beams of the first beam layer; and
if the signal qualities of the beams of the first beam layer or the signal quality based on the first cell are/is less than and/or equal to a fifth threshold, initiating a neighboring cell measurement or a measurement of a second beam layer,
wherein the processor is further configured to call and run the computer program stored in the memory to cause the terminal device to perform an operation of:
measuring signal qualities of beams of a second beam layer in the first cell;
determining a signal quality of the first cell based on the signal qualities of the beams of the second beam layer; and
if the signal qualities of the beams of the second beam layer or the signal quality based on the first cell are/is less than and/or equal to a sixth threshold, initiating a neighbor cell measurement,
wherein the plurality of beam layers in the first cell comprise a first beam layer and a second beam layer, and the first beam layer is closer to a center of the first cell compared to the second beam layer.

15. A network device, comprising a processor and a memory, wherein the memory is configured to store a computer program, and the processor is configured to call and run the computer program stored in the memory to cause the network device to perform an operation of:
performing beam scanning to achieve coverage of a first cell through a plurality of beam layers, wherein different beam layers of the plurality of beam layers correspond to different coverage areas within the first cell.

16. The network device of claim 15, wherein
the plurality of beam layers comprise at least two beam layers whose coverage areas overlap; and/or
the plurality of beam layers comprise at least two beam layers whose coverage areas do not overlap.

17. The network device of claim 15, wherein
different beam layers of the plurality of beam layers use independent index spaces; or
different beam layers of the plurality of beam layers use a unified index space,
wherein indices in the index space are used for numbering beams in the beam layers,
wherein in a case where the different beam layers of the plurality of beam layers use the independent index spaces, a beam is identified by a first index and a second index, wherein the first index is an index of the beam in an index space, and the second index is an index of a beam layer, to which the beam belongs, in the plurality of beam layers,
wherein in a case where the different beam layers of the plurality of beam layers use the unified index space, a beam is identified by a first index, wherein the first index is an index of the beam in the index space,
wherein the index space is a synchronization signal block (SSB) index space.

18. The network device of claim 15, wherein the processor is further configured to call and run the computer program stored in the memory to cause the network device to perform an operation of:
sending first configuration information and/or second configuration information to a terminal device, wherein the first configuration information is used for configuring a number of beam layers comprised in the first cell, and the second configuration information is used for configuring synchronization signal block (SSB) indices actually transmitted by each of the beam layers in the first cell,
wherein
the second configuration information is used for configuring SSB indices actually transmitted in the first cell according to a cell level, and for configuring a corresponding relationship between the SSB indices actually transmitted in the first cell and the beam layers; or
the second configuration information is used for configuring the SSB indices actually transmitted by each of the beam layers in the first cell according to a beam layer level.

19. The network device of claim 15, wherein the processor is further configured to call and run the computer program stored in the memory to cause the network device to perform an operation of:
receiving a random access process initiated by a terminal device based on a first random access resource; wherein the first random access resource is used for indicating a first beam selected by the terminal device and/or a beam layer where the first beam is located; and
sending fourth configuration information to a terminal device, wherein the fourth configuration information is used for configuring an uplink transmission parameter and/or downlink reception parameter used by each of beam layers in the first cell according to a beam layer level.

20. The network device of claim 15, wherein the processor is further configured to call and run the computer program stored in the memory to cause the network device to perform an operation of:
sending first indication information to a terminal device, wherein the first indication information is used for indicating whether the first cell allows terminal devices to use a random access message of a first size, or for indicating whether the first cell allows terminal devices located within a coverage area of a first beam layer to use the random access message of the first size, or for indicating beam layers that the first cell allows terminal devices to use the random access message of the first size, or for indicating a maximum or minimum beam layer index that the first cell allows terminal devices to use the random access message of the first size, or for indicating a boundary beam layer index that the first cell allows terminal devices to use the random access message of the first size,
wherein the plurality of beam layers in the first cell comprise a first beam layer and a second beam layer, and the first beam layer is closer to a center of the first cell compared to the second beam layer.
